(19) United States
(12) Patent Application Publication
(10) Pub. No.: US 2004/0049698 A1
(43) Pub. Date: Mar. 11, 2004

(54) Computer network security system utilizing dynamic mobile sensor agents

(76) Inventors: Allen Eugene Ott, Mission Viejo, CA (US); Frank Ernest Oldham, San Diego, CA (US)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/236,357

(22) Filed: Sep. 6, 2002

(51) Int. Cl. G06F 11/30

(52) U.S. Cl. 713/201

(57) ABSTRACT

A computer network security system utilizes mobile sensor agents that detect host-level activities and report event occurrences to a security server connected to the protected network. The security server processes the event data, assesses the current situation/risk status of the network, and manages the distribution of mobile sensor agents in the network in response to the current status of the network. The security server employs intelligent data fusion techniques to obtain contextually relevant situation/risk data based upon the relatively abstract host-level activity data. The security server can deploy additional mobile sensor agents to monitor for specific events, withdraw active mobile sensor agents installed on client computers, move mobile sensor agents within the protected network, and perform other managerial and regulatory actions that govern the mobile sensor agents.

### FIELD OF THE INVENTION

The present invention relates generally to computer network security systems. More particularly, the present invention relates to the managed distribution of mobile sensor agents within a protected computer network.

### BACKGROUND OF THE INVENTION

The prior art is replete with security systems designed to protect individual computers and/or computer networks. The sophistication of such prior art systems varies from simple virus detection software to more complex network intrusion detection applications. In this regard, a computer network can utilize a relatively simple virus protection program to detect known computer viruses and/or a relatively rigorous security application designed to thwart the efforts of highly skilled and malicious hackers.

Most computer network security techniques rely on the observation and analysis of incoming traffic via limited point entrances into the network, along with pattern recognition of known attack signatures. While these techniques may adequately protect the network against individual or unsophisticated attackers, they may not provide sufficient protection against sophisticated, well-organized, and highly funded attackers. For example, many known network security systems are incapable of detecting a network security breach that involves multiple points of attack and/or an attack that is slowly carried out over a long period of time. Indeed, security systems that employ attack signature recognition techniques will generally fail to detect new attacks that do not match any of the known attack signatures.

Many prior art computer network security systems are difficult to reconfigure with additional capabilities and/or upgrade to provide protection against newly discovered attack methodologies. Such known security systems often utilize local applications installed on each of the protected computers within the network. Upgrading such a security system requires the installation of new applications or patches on each of the protected computers. In the context of a large network, such upgrading can be very expensive and time consuming. Furthermore, conventional security systems collect and attempt to analyze increasing amounts of data in response to the discovery of new attack signatures and in response to the addition of protected computers. Consequently, the amount of resources devoted to the collection and analysis of security data increases significantly with the expansion of the protected network and/or the expansion of the scope of protection.

### BRIEF SUMMARY OF THE INVENTION

A computer network security system in accordance with the present invention provides an increased level of protection against sophisticated attacks, relative to most known security systems. The network security system improves attack detection rates while reducing false alarms. The network security system utilizes adaptive techniques that enable it to protect against known attack patterns and unknown attack methodologies. Furthermore, the network security system can be easily reconfigured and updated because it need not rely on customized local applications.

The above and other aspects of the present invention may be carried out in one form by a computer network security method that provides a number of mobile sensor agents for deployment in a computer network, receives event data from one or more of the mobile sensor agents, where the event data corresponds to detected event occurrences, and manages, in response to the event data, the distribution of mobile sensor agents in the computer network.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation of a local area network in which the techniques of the present invention may be deployed;

FIG. 2 is a schematic representation of a wide area network in which the techniques of the present invention may be deployed;

FIG. 3 is a diagram that depicts the managed distribution of mobile sensor agents in a computer network;

FIG. 4 is a schematic representation of a fusion component;

FIG. 5 is a schematic representation of a sensor distribution manager; and

FIG. 6 is a flow diagram of a network security process.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, logic elements, loo-kup tables, and the like, which may carry out a variety of functions under the control of one or more microprocessors or other control devices. In addition, those skilled in the art will appreciate that the present invention may be practiced in conjunction with any number of computer system architectures and that the computer network described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional techniques for data transmission, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

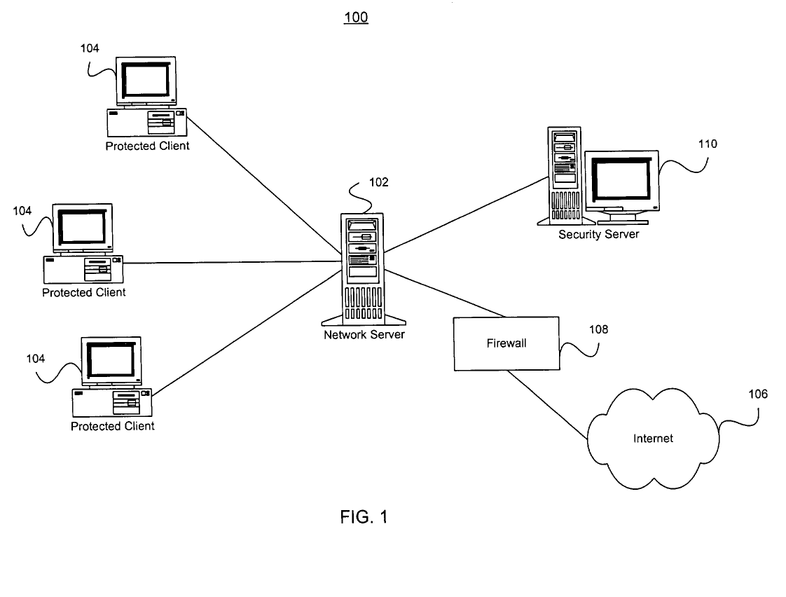

The techniques of the present invention can be used to protect a computer network against hacker attacks, to protect the integrity of information stored on a computer network, to protect against unauthorized use of the computer network, and the like. In this regard, FIG. 1 is a schematic representation of a local area network (LAN) 100 in which a network security system according to the present invention may be deployed. LAN 100 includes at least one network server 102 and at least one client computer 104 (in a practical embodiment, LAN 100 can include any number of client computers). In accordance with conventional computer networking techniques and technologies, client computers 104 are connected to network server 102 such that data can be routed between client computers 104 and network server 102. For purposes of this description, the manner in which network server 102 and client computers 104 are interconnected is unimportant. LAN 100 may be suitably configured to access the Internet, an Intranet, a wide area network, or the like. For example, FIG. 1 depicts LAN 100 having access to the Internet 106 via a firewall 108. Firewall 108, which may be implemented in hardware, software, firmware, or a combination thereof, functions in a conventional manner to prevent unauthorized access to LAN 100 via the Internet 106. In a practical deployment, a security server 110 may be connected to LAN 100. As described in more detail below, security server 110 is suitably configured to perform various network security processes related to the present invention.

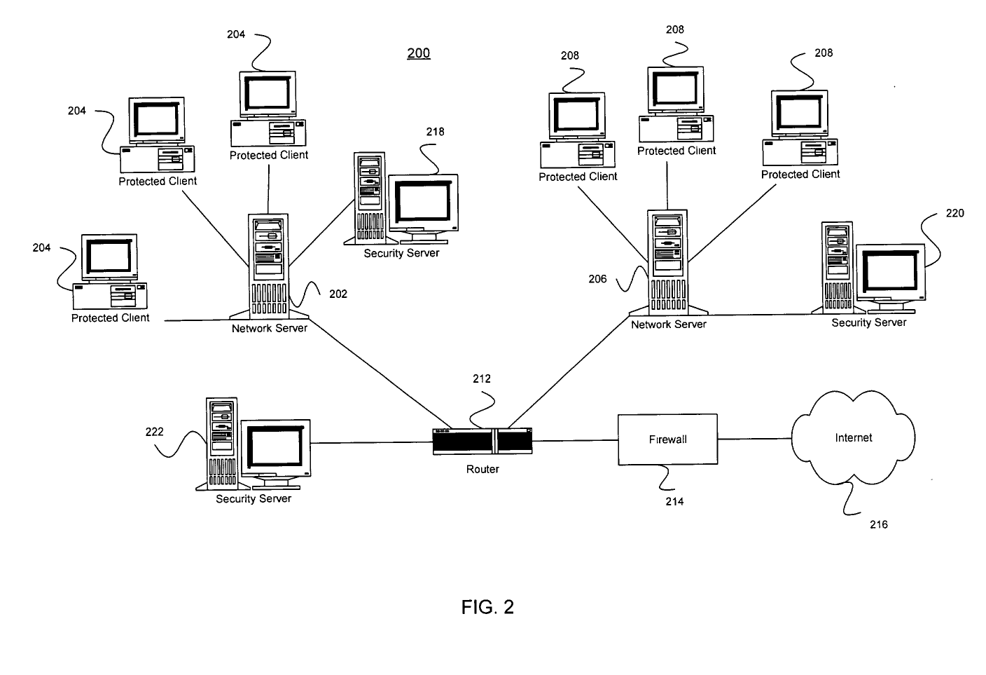

As shown in FIG. 2, the techniques of the present invention may also be utilized in the context of a wide area network (WAN) 200. Conceptually, WAN 200 may be considered to be a combination of two or more LANs. For example, WAN 200 may include a first network server 202 that supports a number of client computers 204, and a second network server 206 that supports a number of client computers 208 (in a practical embodiment, WAN 200 can include any number of client computers and any number of network servers interconnected to form any suitable architecture). First network server 202 and second network server 206 may be connected via a conventional router 212. As described above in connection with FIG. 1, WAN 200 can employ any number of firewalls 214 to protect against unwanted access via the Internet 216. Although not a requirement of the present invention, a preferred WAN deployment includes a plurality of security servers. For example, WAN 200 may include a first security server 218 that primarily protects client computers 204, a second security server 220 that primarily protects client computers 208, and a third security server 222 connected to router 212.

In practice, each of the client computers protected by the network security system is a personal computer (PC) having conventional hardware and software components, e.g., memory elements, a display monitor, an operating system, data communication ports for transmitting and receiving data via the respective network, a processor chip, any number of application programs, a web browser application, and the like. Of course, the network security system may also be configured to protect other components or features of the protected network, e.g., peripherals, servers, routers, databases, and the like. As described in more detail below, the currently preferred network security system utilizes mobile software agents written in Java. Consequently, the protected client computers are Java-compatible such that they can properly install and run the Java runtime environment as needed. Furthermore, the protected client computers also employ a suitably configured agent server application that enables the client computers to receive, send, and process the mobile software agents. The design of the agents and/or the agent server application may leverage any number of known technologies, such as the open source Aglets Software Development Kit available from IBM Corporation.

Although not a requirement of the network security system, a security server is preferably realized as a stand-alone PC having a display monitor, a mouse, a keyboard (or other user interface), at least one data communication port configured to receive data from the protected client computers or other network components (e.g., event data from mobile sensor agents), and other common hardware and software features. In a practical deployment, devoted security servers facilitate real-time monitoring of the network security status and/or manipulation of the network security system features by human operators. Notably, each security server preferably includes memory space and processing power sufficient to support the operation of the network security system as described herein. In addition to a conventional operating system and (possibly) any number of conventional software applications, each security server includes one or more software programs that perform the various routines and processes described herein. In addition, the functional block components shown in the figures can be implemented in a security server using one or more computer programs. In a practical deployment, the functionality of the security server can be realized as one or more computer programs embodied on a computer-readable medium, e.g., a hard drive or other magnetic storage device, a CD-ROM, a floppy disk, a ROM chip, a firmware device, or the like. In accordance with conventional computer science techniques, the computer programs include computer-executable instructions for carrying out the various processing tasks described herein.

After the security server (or servers) are physically connected to the network, or after the security server software is loaded onto an existing network server, the security server deploys a number of mobile sensor agents throughout the network. The sensor agents detect occurrences of specified events; an event may be a component of a known attack signature or any detectable event associated with the operation of the protected client computers or the protected computer network. The sensor agents communicate event data back to the respective security server for analysis and processing. The security server processes the event data to determine the security status of the network and to determine whether it would be beneficial to obtain additional event data in order to better assess the security status of the network. The security server manages the distribution of mobile sensor agents in the protected network according to the current security risk. In this manner, the number and type of mobile sensor agents and the amount of client computer resources devoted to the network security system are dynamically regulated, monitored, and managed in substantially real-time to provide an appropriate level of network protection.

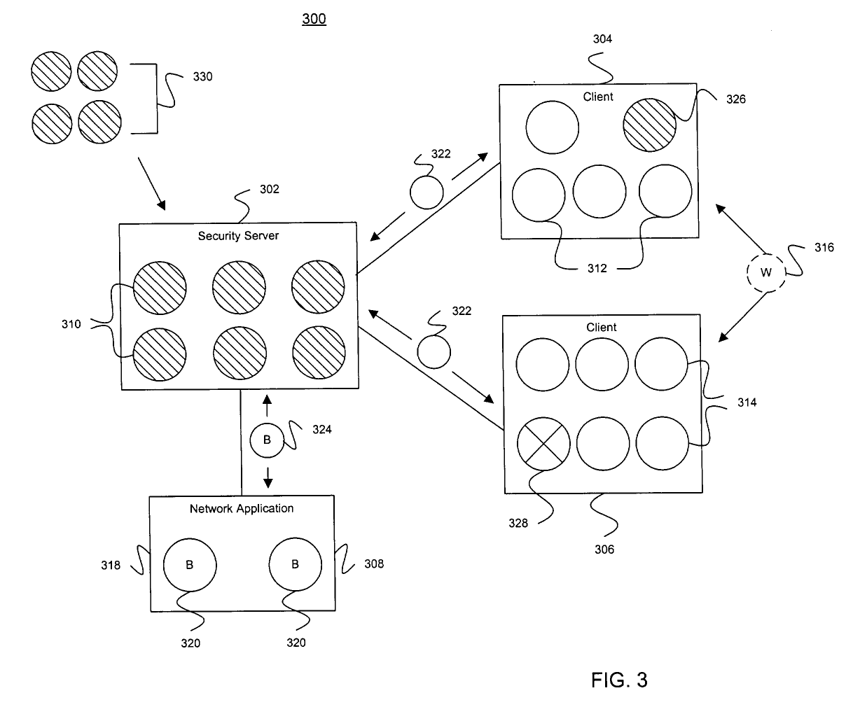

FIG. 3 is a diagram that depicts the managed distribution of mobile sensor agents in an example computer network 300 protected by a network security system according to the present invention. For purposes of this example, computer network 300 includes a security server 302, a protected client computer 304, a protected client computer 306, and a network application 308. Security server 302 maintains any number of “inactive” or “dormant” mobile sensor agents 310. These dormant mobile sensor agents 310 are capable of being distributed to various points in computer network 300; dormant mobile sensor agents are activated such that they can perform their designated tasks once they reach their destination in computer network 300. For the sake of illustration, dormant or inactive mobile sensor agents are shaded in FIG. 3.

Once deployed and installed on a client computer, a mobile sensor agent detects events and reports event data back to security server 302. As used herein, a field agent is a mobile sensor agent that is distributed from security server 302 to one specific protected client computer. FIG. 3 depicts a number of field agents 312 associated with client computer 304 and a number of field agents 314 associated with client computer 306. Field agents are deployed to a specific client computer (or other location in computer network 300), where they reside and function until withdrawn or deactivated or until they expire. The security system may also employ a number of wandering sensor agents 316 that travel among a plurality of client computers (or other locations in computer network 300). In this regard, wandering sensor agent 316 may be designed to perform a specified task at client computer 304, then travel to client computer 306 to perform the same specified task. Alternatively, wandering sensor agent 316 may be instructed to perform different tasks at different locations within computer network 300. The routine followed by wandering sensor agent 316 may be predetermined by security server 302, or it may be controlled in response to the changing security status of computer network 300 and/or in response to operator commands.

The security system may also support the deployment of one or more mobile sensor agents that function as broker agents. As used herein, a broker agent obtains raw event data from an application installed in the protected computer network, and sends corresponding event data back to the security server. In this regard, FIG. 3 shows a network application 318 and a number of associated broker agents 320. Network application 318 may be, for example, a network traffic analysis program, a user authentication program, an antivirus program, a firewall application, or the like. Broker agents 320 receive data from “sensors” built into the network application and forward such data to the network security system. In this manner, the network security system can process and analyze event data obtained indirectly from other applications.

FIG. 3 shows mobile sensor agents 322 in transit between security server 302 and client computers 304, 306. FIG. 3 also shows a mobile broker agent 324 in transit between security server 302 and network application 318. FIG. 3 thus illustrates the dynamic and mobile nature of the various mobile sensor agents, which are distributed in computer network 300 under the control of security server 302. In response to the changing risk and security status of computer network 300, security server 302 can distribute and/or allocate additional mobile sensor agents to appropriate locations within the network. In addition, security server 302 can activate dormant sensor agents (e.g., mobile sensor agent 326 maintained by client computer 304), deactivate active mobile sensor agents, withdraw mobile sensor agents that are no longer needed, and/or terminate or delete mobile sensor agents that are no longer needed (a deleted or withdrawn mobile sensor agent 328 is shown in connection with client computer 306). Furthermore, the network security system is adaptable to accommodate new sensor agents 330 that detect additional events that are currently unmonitored. For example, in response to new attack signatures or suspected network vulnerabilities, new mobile sensor agents 330 may be installed on security server 302 for managed distribution in computer network 300. In this manner, every client computer in computer network 300 need not be periodically updated to provide protection against new threats.

The various types of mobile sensor agents (e.g., field agents, broker agents, and wandering agents) share many functional characteristics. For example, when deployed in the client computers, a mobile sensor agent resides in the application layer of the host processor, along with a suitable agent server. The mobile sensor agent is configured to communicate directly with the operating system of the host processor, via the kernel layer. The mobile sensor agents detect “low level” data corresponding to abstract events or activities rather than “high level” contextual data or data related to attack signatures. The mobile sensor agents detect events even if the events themselves are not predefined components of an attack. In other words, rather than detect the occurrence of an attack itself, the mobile sensor agents look for elemental evidence of activities and events that could be a constituent part of an attack. In this regard, the mobile sensor agents can be lightweight in design and they need not consume a large amount of the host processor resources.

Table 1 contains a list of example events corresponding to the functionality of different mobile sensor agents. The events listed in Table 1 represent host-level event occurrences related to protected client computer activity. In a practical deployment, the set of events may never be finalized, and a complete and exhaustive set would include all sensors necessary to fully monitor all events within a network; such an implementation would be inefficient for practical applications. The number of detectable events may increase as attackers learn to use different types of network and client activities to perpetrate their efforts. The mobile sensor agents may also change as the attackers learn to use network and client activities in different ways, thus prompting enhancement of the sensor agent specifications.

TABLE 1
Detectable Events

| Event | Event Description |
|---|---|
| Query | Indication of an event whereby an attacker queries the |
| Data | network, or computers within the network, for |
| | identification, configuration, or functional capabilities. |
| Login | Statistical data related to login attempts and/or failures. |
| Character- | |
| istics | |
| Connection | Any event, process, or status of successful or unsuccessful |
| Information | connection to the network by computers within the network. |
| Connection | Any event that establishes or changes the connection |
| Data | information between the computers within the network |
| | and/or any other resource or device. |
| Network | Any event that indicates the establishment of change in |
| Data | network configuration or network service configuration. |
| Computer | Any event that reflects the establishment or change of a |
| OS Data | computer operating system or operating system service |
| | within the network. |
| Computer | Any event that reflects the establishment or change in the |
| Resource | resources available to any process within the computer or |
| Data | within the network. |
| Covering | Any event that indicates an effort to modify or avoid the |
| Events | recording of events related to various processes within the |
| | computer or network, including, but not limited to, logs, |
| | records, and file systems. |
| Usage Data | Any event that would indicate a usage of the computers or |
| | network resources outside the expected normal processes as |
| | defined by policy, practice, or precedence. |

A particular mobile sensor agent may be designed to detect one or more distinct event occurrences. For example, one mobile sensor agent may be specifically limited to the detection of unauthorized software, while another mobile sensor agent may be designed to detect the number of SMTP connections and the number of FTP connections. Each mobile sensor agent reports the detected event occurrences back to the respective security server in the form of event data. The event data may be formatted in accordance with any suitable scheme that enables the security server to receive, interpret, and process the event data.

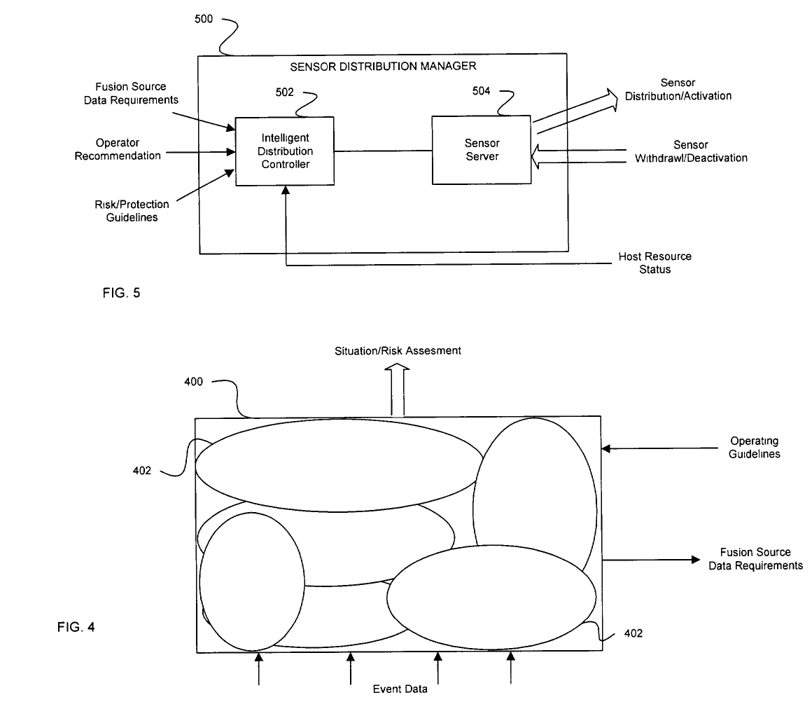

FIG. 4 is a schematic representation of a fusion component 400 utilized by the network security system. In a practical embodiment, each security server includes a fusion component 400 configured to process event data received from the mobile sensor agents. Fusion component 400 can be implemented in software, hardware, firmware, or any combination thereof; in a preferred embodiment, fusion component 400 is implemented in software. Briefly, fusion component 400 processes the event data using one or more fusion agents 402, each specializing in a potential network security issue. As used herein, a “network security issue” can be a component of a known attack, a known attack signature, a network vulnerability, a monitored network function or feature, or the like. In FIG. 4, each ellipse represents a fusion agent 402, and the area within the rectangle represents all network vulnerabilities and potential attack scenarios. Ideally, the fusion agents 402 in combination will provide adequate protection against all potential attack scenarios, both known and unknown.

In a practical implementation, each fusion agent 402 will receive and process a limited amount of event data. For example, referring to Table 1, a fusion agent 402 will typically receive and process only a subset of the listed events. In addition, any number of different fusion agents 402 can receive and process the same event data, i.e., event data need not be exclusive to any particular fusion agent 402. In the preferred embodiment, any number of fusion agents 402 can process the event data using one or more intelligent decision-making techniques (e.g., artificial intelligence techniques, expert system techniques, neural network techniques, and the like). Furthermore, any number of the fusion agents 402 may be collaborative fusion agents capable of communicating with one another. The collaborative nature of the fusion agents makes the network security system more interactive and adaptable to accommodate different security threats and attack patterns. Although not normally mobile within a given network, fusion agents 402 may be configured for travel or distribution from one security server to another security server.

Fusion component 400 analyzes the event data and, considering a set of operating guidelines dictated by the operator of the network security system, assesses the situation/risk status of the computer network based upon the event data. The set of operating guidelines specify the security services available to network users, identify data accessible to certain users and the manner in which such data can be accessed, and the like. In this regard, fusion component 400 receives the relatively low level abstract event data and generates an output of relatively high level contextual information representing the current security status of the network. In addition, fusion component 400 is further configured to determine the need for additional event data (to be obtained from additional mobile sensor agents) based upon the assessed situation/risk status. In this regard, fusion component 400 is configured to generate requests for additional event data (i.e., fusion source data requirements).

In a practical embodiment, a fusion agent 402 will analyze the current set of event data to which it has direct access, along with any event data (or other data) to which it has access via other fusion agents. Using its intelligent decision-making processes, the fusion agent 402 will determine whether a security threat is present and, if so, the severity of the security issue and/or the risk associated with the security issue. If the fusion agent 402 determines that little or no threat or risk is present, then it may generate fusion source data requirements corresponding to no change in the status of the relevant mobile sensor agents. Alternatively, it may generate fusion source data requirements corresponding to a request to reduce the amount of mobile sensor agents and/or other resources devoted to the detection of that particular threat. On the other hand, if fusion agent 402 determines that a measurable threat or risk is present (or if it cannot make any intelligent risk assessment), then it may generate fusion source data requirements corresponding to a request to increase the amount of mobile sensor agents and/or other resources devoted to the detection of that particular threat.

Fusion component 400 can also consider metadata related to the received event data, which is received and processed virtually in real-time. For example, metadata related to the event data may be: the username and password of the user of the client computer where the detected event occurred; the purpose or function of the respective client computer, e.g., server, workstation, or secretarial; the current security status of the respective client computer; the current security status of the protected network; a history of events for the respective client computer; a statistical profile of events for the respective client computer; the identities of other client computers that frequently communicate with the respective client computer; and the like. Such metadata can be used, with or without event data, to evaluate the situation/risk status of the protected network over relatively long periods of time or to determine whether the protected network is being subjected to an organized distributed attack.

FIG. 5 is a schematic representation of a sensor distribution manager 500 utilized by the network security system. Distribution manager 500 can be implemented in software, hardware, firmware, or any combination thereof; in a preferred embodiment, distribution manager 500 is implemented in software. In a practical embodiment, a sensor distribution manager 500 is implemented in each security server employed by the network security system. Briefly, distribution manager 500 is configured to manage the distribution of mobile sensor agents in the computer network in response to a number of operating criteria and/or data inputs. For purposes of this description, “managing the distribution” of mobile sensor agents encompasses a variety of functions, including, but not limited to: initially deploying sensor agents throughout the network; dispatching new or additional sensor agents to points in the network while the network security system is monitoring the network; allocating sensor agent resources for use in the network; controlling the movement of wandering sensor agents in the network; activating and deactivating sensor agents deployed in the network; withdrawing, deleting, and terminating sensor agents deployed in the network; monitoring the location and/or status of deployed sensor agents; and the like.

Conceptually, sensor distribution manager 500 includes an intelligent distribution controller 502 that cooperates with a sensor server 504. These functional components are shown as distinct elements in FIG. 5 to facilitate the description of distribution manager 500—in reality, distribution manager 500 need not be partitioned into such functional elements. Distribution controller 502 receives data that influences the distribution of mobile sensor agents in the protected computer network, and generates commands or instructions for controlling the distribution of the mobile sensor agents. The instructions are processed by sensor server 504, which responds by distributing, activating, withdrawing, deactivating, and/or moving one or more mobile sensor agents in the protected network.

As shown in FIG. 5, distribution controller 502 may consider one or more of the following: fusion source data requirements (i.e., requests for additional event data, which may correspond to the deployment of additional mobile sensor agents); operator recommendations; risk/protection guidelines; and host resource status data. In addition to the above criteria, distribution controller 502 may process any number of additional criteria or data types. As described above in connection with fusion component 400, sensor distribution manager 500 considers the results generated by fusion component 400. In other words, requests related to the collection of additional event data and/or other fusion source data requirements are fed to distribution controller 502 for evaluation. Operator recommendations are explicit instructions provided by a user of the network security system. For example, a user stationed at a security server may request the deployment of one or more specific mobile sensor agents to a particular client computer in response to a perceived risk. Indeed, the security system may allow a user to recommend any number of changes or adjustments to the current security settings or mobile sensor agent deployment. Depending upon the specific application, a user may be authorized to completely override the decisions made by distribution manager 500 or a user may only be permitted to enter suggestions or recommendations. Risk/protection guidelines refer to general rules that govern the distribution of mobile sensor agents in a particular computer network. In this regard, risk/protection guidelines can vary from application to application. The risk/protection guidelines may define any number of operational rules, such as: the maximum amount of host processor resources that can be devoted to the network security system (which may vary depending upon the current risk assessment); a list of activities or events that must be continuously or periodically monitored; the number of mobile sensor agents that can be distributed to a single client computer (which may vary depending upon the current risk assessment); and the like. Distribution controller 502 may also process data representing the current host resource status of one or more of the protected client computers in the network. In one practical embodiment, the network security system may only consume approximately three percent of the processing power of any client computer. However, in response to a heightened security risk, the security system may be authorized to consume more than three percent of the host processing power. Distribution controller 502 can process the current status of the host resources to determine how best to manage the distribution of mobile sensor agents in the network.

In the preferred embodiment, the network security system evaluates the host processor performance, the amount of resources devoted to the security system, and the current risk assessment, and performs a trade-off between host processor performance and network protection. In response to the fusion source data requirements, any operator recommendations, risk/protection guidelines for the protected network, the current host resource status, and possibly other criteria, distribution controller 502 generates one or more sensor distribution instructions to be carried out by sensor server 504. Consequently, distribution manager 500 can manage the distribution of mobile sensor agents in the protected network in response to user recommendations, established risk/protection guidelines, requests for additional event data (which may be generated by fusion component 400), and/or the resource status of at least one protected client computer in the network.

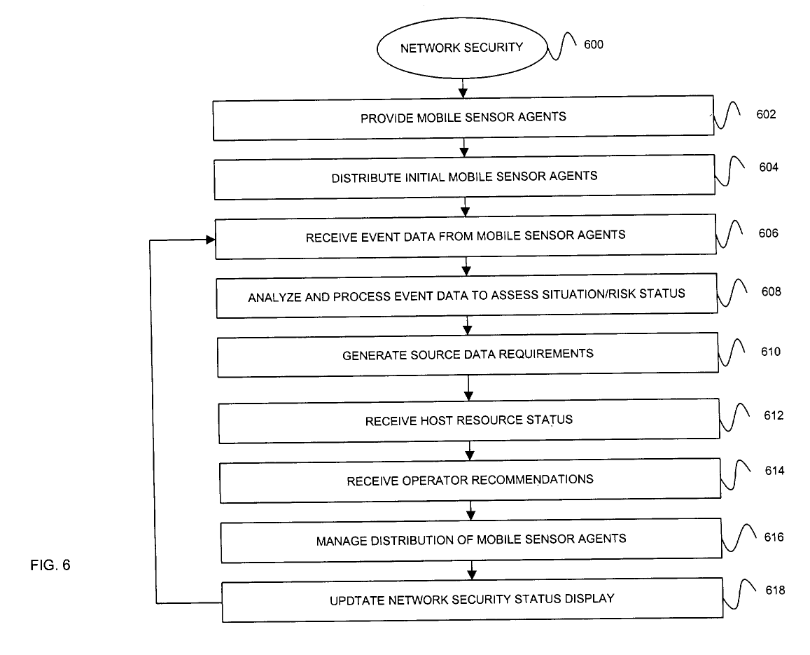

FIG. 6 is a flow diagram of a network security process 600 performed by a network security system configured in accordance with the present invention. Although process 600 illustrates a number of common functions performed by a practical network security system, in actual use a security system may perform a number of additional or alternative functions. Process 600 assumes that the respective client computers are suitably configured for compatibility with the network security system, and that a suitably configured security server (or servers) is installed on the protected computer network.

Network security process 600 begins by providing a number of mobile sensor agents for deployment in the protected network (task 602). In this context, any number of mobile sensor agents can be provided to the security server at the initial installation of the security system or at any subsequent time, any number of broker agents can be directly provided to respective applications or information sources throughout the network, and/or any number of mobile sensor agents can be directly provided to one or more client computers. In a typical installation, a number of dormant sensor agents (and possibly a number of active sensor agents) will be provided to the security server during task 602, with little or no direct installation of sensor agents at the client level.

The security server may distribute one or more initial mobile sensor agents (e.g., active or inactive field agents, wandering agents, and broker agents) to various points in the protected network (task 604). The set of initially distributed mobile sensor agents, and the destinations of those sensor agents, are dictated by the specifications and requirements of the protected network. For example, one network may require a relatively low number of initial sensor agents, while another network may require a relatively complex initial installation of sensor agents. Once deployed and activated, these mobile sensor agents perform their designated functions and they begin monitoring for the occurrence of specific activities on the protected network.

Eventually, the security server receives event data from one or more mobile sensor agents (e.g., wandering sensor agents, broker agents, and/or field agents), where the event data corresponds to detected event occurrences (task 606). In a preferred practical embodiment, data transmitted between client computers and security servers is encrypted using a suitable encryption algorithm. The encryption of the event data adds a layer of security to the system and protects against the unauthorized interception of the security system communications. As described in more detail above, the event occurrences detected by the mobile sensor agents need not be components of a known or suspected attack. Rather, the events can relate to host processor activities that may be legitimate and normal under many circumstances. Thus, the received event data may be abstract host-level event data related to protected client computer activity.

As described above, the security server analyzes and processes the received event data to assess the current situation/risk status (task 608). The security server also generates source data requirements (e.g., requests for additional event data) in response to the received event data (task 610). In the example embodiment, task 608 and task 610 are performed by fusion component 400. The security server may receive the current host resource status from the protected client computers (task 612), along with any operator recommendations entered by an operator of the security server (task 614). In a practical embodiment, the security server receives the host resource status data via the network and via its data communication port, and it receives the operator recommendation data directly from a keyboard, a mouse, or any suitable user interface device.

In response to the received event data, the security server manages the distribution of one or more mobile sensor agents in the protected computer network (task 616). As mentioned above, the management of the mobile sensor agents by the security server is also responsive to the host resource status, the designated risk/protection guidelines, and operator recommendations. During task 616, the security server can manage, without limitation: the deployment of additional mobile sensor agents from the security server to protected client computers or elsewhere in the network; the activation of at least one dormant or deactivated mobile sensor agent installed in a client computer; the deactivation of at least one active mobile sensor agent installed in a client computer; and/or the withdrawal or deletion of at least one mobile sensor agent from a client computer. Generally, the security server can be configured to manage any number of actions related to the distribution, allocation, movement, operation, control, and/or regulation of mobile sensor agents within the protected network. In this respect, the security system may utilize server and client packages to manage a number of issues such as: the deployment of sensor agents to a specific client computer; communication between the security server and sensor agents for purposes of sensor withdrawal, sensor reallocation, sensor deactivation, sensor activation, or designation of sensor functionality; and the like. In a practical embodiment, the security system can utilize a local security zone manager or security client that runs on the protected hosts and manages such issues. The local security clients ensure that the host identification is available in the registry of the security server, ensure that the appropriate security provisions are in place for secure interaction (including encryption key management), and manages the three-way trade-off between local sensor configuration, data collection requests, and local host processing resources.

The network security system can display or otherwise convey the current situation/risk status of the protected network in virtually real-time to an operator of the system (task 618). In the preferred embodiment, the security server includes a display monitor and the security server is capable of rendering a graphical representation of the network status for display on the monitor. For example, the situation/risk status of the network can be displayed in any convenient manner that enables an operator to quickly determine whether any given client computer is vulnerable or under attack. In turn, the operator can make security decisions based on the displayed information.

The network security system is capable of providing dynamically adaptable protection for a computer network, and such protection is provided in a continuous manner. Accordingly, many of the tasks described in connection with network security process 600 are repeated and performed in a continuous manner.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A computer network security method comprising:
providing a number of mobile sensor agents for deployment in a computer network, each of said mobile sensor agents being configured to detect event occurrences;
receiving event data from one or more of said mobile sensor agents, said event data corresponding to detected event occurrences; and
managing, in response to said event data, the distribution of one or more of said mobile sensor agents in said computer network.

2. A method according to claim 1, wherein said managing step manages the deployment of at least one mobile sensor agent from a security server connected to said computer network to a protected client computer in said computer network.

3. A method according to claim 1, wherein said managing step manages the activation of at least one dormant mobile sensor agent installed in a protected client computer in said computer network.

4. A method according to claim 1, wherein said managing step manages the deactivation of at least one active mobile sensor agent installed in a protected client computer in said computer network.

5. A method according to claim 1, wherein said managing step manages the withdrawal of at least one mobile sensor agent from a protected client computer in said computer network.

6. A method according to claim 1, wherein said mobile sensor agents are configured to detect host-level event occurrences related to protected client computer activity.

7. A method according to claim 6, wherein receiving event data comprises receiving abstract host-level event data related to protected client computer activity.

8. A method according to claim 1, wherein said providing step comprises providing a number of mobile sensor agents to at least one security server connected to said computer network.

9. A method according to claim 1, wherein said providing step comprises providing a number of mobile sensor agents to at least one protected client computer in said computer network.

10. A method according to claim 1, wherein said managing step manages the distribution of one or more of said mobile sensor agents in response to user recommendations.

11. A method according to claim 1, wherein said managing step manages the distribution of one or more of said mobile sensor agents in response to established risk/protection guidelines.

12. A method according to claim 1, wherein said managing step manages the distribution of one or more of said mobile sensor agents in response to requests for additional event data.

13. A method according to claim 1, wherein said managing step manages the distribution of one or more of said mobile sensor agents in response to resource status of at least one protected client computer in said computer network.

14. A method according to claim 1, wherein said receiving step receives event data from at least one wandering sensor agent that travels among a plurality of protected client computers in said computer network.

15. A method according to claim 1, wherein said receiving step receives forwarded event data from at least one broker agent that obtains raw event data from an application installed in said computer network.

16. A method according to claim 1, wherein said receiving step receives event data from at least one field agent that is specific to one protected client computer in said computer network.

17. A network security computer program, said computer program being embodied on a computer-readable medium, said computer program having computer-executable instructions for carrying out a method comprising:
providing a number of mobile sensor agents for deployment in a computer network, each of said mobile sensor agents being configured to detect event occurrences;
receiving event data from one or more of said mobile sensor agents, said event data corresponding to detected event occurrences; and
managing, in response to said event data, the distribution of one or more of said mobile sensor agents in said computer network.

18. A computer network security server comprising:
a distribution manager configured to manage the distribution of mobile sensor agents in a computer network, each of said mobile sensor agents being configured to detect event occurrences;
at least one data communication port configured to receive event data from one or more mobile sensor agents deployed in said computer network; and
a fusion component configured to process said event data and generate requests for additional event data; wherein
said distribution manager manages the distribution of mobile sensor agents in response to said requests.

19. A security server according to claim 18, wherein said fusion component is further configured to assess the situation/risk status of said computer network based upon said event data.

20. A security server according to claim 19, wherein said fusion component is further configured to determine the need for said additional event data based upon said situation/risk status.

21. A security server according to claim 18, wherein said at least one data communication port is configured to receive said event data via said computer network.

22. A security server according to claim 18, wherein said fusion component comprises one or more fusion agents, each specializing in a potential network security issue.

23. A security server according to claim 22, wherein at least one of said fusion agents is configured to process said event data using an intelligent decision-making technique.

24. A security server according to claim 22, wherein a number of said fusion agents are collaborative fusion agents capable of communicating with one another.
